(19) United States
(12) Patent Application Publication
(10) Pub. No.: US 2023/0356229 A1
(43) Pub. Date: Nov. 9, 2023

(54) HEATING ELEMENTS SURROUNDING MULTIPLE SIDES OF FLUID CHAMBERS

(71) Applicant: HEWLETT-PACKARD DEVELOPMENT COMPANY, L.P., Spring, TX (US)

(72) Inventors: Carson Denison, Corvallis, OR (US); Erik D. Torniainen, Corvallis, OR (US); Richard W. Seaver, Corvallis, OR (US)

(73) Assignee: HEWLETT-PACKARD DEVELOPMENT COMPANY, L.P., Spring, TX (US)

(21) Appl. No.: 17/909,585

(22) PCT Filed: Mar. 30, 2020
(86) PCT No.: PCT/US2020/025786

§ 371 Date: Sep. 6, 2022

(51) Int. Cl. B01L 7/00

(52) U.S. Cl. CPC B01L 7/52; B01L 2300/1883

(57) ABSTRACT

In one example in accordance with the present disclosure, a thermal cycling device is described. The thermal cycling device includes a fluid chamber to retain a fluid. A heating element is disposed around multiple sides of a cross-sectional perimeter of the fluid chamber and an insulator is disposed around multiple sides of a cross-sectional perimeter of the heating element. The thermal cycling device also includes a conductive body disposed around multiple sides of a cross-sectional perimeter of the insulator.

### BACKGROUND

Molecular biology is a field of biology that studies the structure, function, and operation of cells. With an understanding of the structure, function, and operation of cells, a variety of chemical reactions and processes can be carried out. Polymerase chain reaction (PCR) amplification is a process to make millions of copies of a particular sample of DNA. With the increased quantity, any number of different studies, experiments, and tests may be carried out on the DNA sample.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a thermal cycling device with a heating element surrounding multiple sides of a fluid chamber, according to an example of the principles described herein.

FIG. 2 is a diagram of a thermal cycling device with a heating element surrounding multiple sides of a fluid chamber, according to an example of the principles described herein.

FIGS. 3A-3F are diagrams of thermal cycling devices with heating elements surrounding multiple sides of fluid chambers, according to an example of the principles described herein.

FIGS. 4A-4H are diagrams of thermal cycling devices with heating elements surrounding multiple sides of fluid chambers, according to an example of the principles described herein.

FIGS. 5A and 5B are diagrams of thermal cycling devices with heating elements surrounding multiple sides of fluid chambers, according to an example of the principles described herein.

FIG. 6 is a diagram of a thermal cycling device with a heating element surrounding multiple sides of a fluid chamber, according to an example of the principles described herein.

FIG. 7 is a diagram of a thermal cycling device with a heating element surrounding multiple sides of a fluid chamber, according to an example of the principles described herein.

FIG. 8 is a diagram of a thermal cycling device with a heating element surrounding multiple sides of a fluid chamber, according to an example of the principles described herein.

FIG. 9 is a diagram of a thermal cycling device with a heating element surrounding multiple sides of a fluid chamber, according to an example of the principles described herein.

FIG. 10 is a diagram of a thermal cycling device with a heating element surrounding multiple sides of a fluid chamber, according to an example of the principles described herein.

FIG. 11 is a diagram of a thermal cycling device with a heating element surrounding multiple sides of a fluid chamber, according to an example of the principles described herein.

FIG. 12 is a block diagram of a thermal cycling system with heating elements surrounding multiple sides of fluid chambers, according to an example of the principles described herein.

FIG. 13 is a diagram of a thermal cycling system with heating elements surrounding multiple sides of fluid chambers, according to an example of the principles described herein.

FIG. 14 is a diagram of a thermal cycling system with heating elements surrounding multiple sides of fluid chambers, according to an example of the principles described herein.

FIG. 15 is a diagram of a thermal cycling system with heating elements surrounding multiple sides of fluid chambers, according to an example of the principles described herein.

FIG. 16 is a flow chart of a method of forming a thermal cycling device with a heating element surrounding multiple sides of a fluid chamber, according to an example of the principles described herein.

FIGS. 17A and 17B are diagrams of the formation of a thermal cycling device with a heating element surrounding two sides of a fluid chamber, according to an example of the principles described herein.

FIGS. 18A-18G are diagrams of the formation of a thermal cycling device with a heating element surrounding four sides of a fluid chamber, according to an example of the principles described herein.

FIG. 19 is a flow chart of a method of using a thermal cycling device with a heating element surrounding multiple sides of a fluid chamber, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Molecular biology is a field of biology that studies the structure, function, and operation of cells. With an understanding of the structure, function, and operation of cells a variety of chemical reactions and processes can be carried out. For example, individual cells may be used to generate additional cells, perform genetic testing, and identify infection agents.

Scientists may conduct a polymerase chain reaction (PCR) to generate high quantities of deoxyribonucleic acid (DNA) on which studies are performed. Specifically, a PCR operation makes millions to billions of copies of a specific DNA sample. As such, a scientist may take a small sample of DNA and amplify it to a large number of copies, such that it may be studied in detail. During PCR, a sample is quickly heated to around 100 degrees Celsius (C) and then cooled to around 50 degrees C. This process is repeated tens of times.

While operations such as PCR greatly enhance the ability of scientists to carry out a variety of experiments, some advancements to devices that carry out PCR may further increase its efficacy and use in scientific laboratories and doctors' offices.

For example, some systems may not be able to change the fluid temperature rapidly. For example, some PCR devices take around 30 minutes to 1 hour to complete the PCR cycles

In addition to being slow, some devices may lack control over the temperature uniformity within the fluid. This lack of control results in dead zones that, due to not being properly heated, may have a reduced efficiency and may not produce the desired output product. Moreover, it may be the case that a PCR device has a capacity of one sample at a time.

Accordingly, the present specification describes a thermal cycling device that addresses these and other issues. Specifically, the present specification describes a thermal cycling device that heats the fluid chamber from multiple sides, thus reducing the overall time to heat a sample. That is, by heating the fluid from all sides and by choosing the geometry of the fluid chamber based on the thermal properties of the materials, the thermal cycling device of the present specification can heat and cool fluid to desired temperatures in less time, with more uniform temperature distributions, and with less waste heat entering the ambient system. In fact, modelling results predict the ability for the thermal cycling device of the present specification to perform a PCR cycle in milliseconds; 100 times faster than other systems. Specifically, the thermal cycling device of the present specification may do a full PCR run in under a tenth of a second, with individual cycles on the order of milliseconds. In one application, a PCR operation could be performed within the time limit of a doctor's visit and would avoid sending the samples to a lab. In addition, the present thermal cycling device has the capability to analyze multiple samples at one.

Specifically, the thermal cycling device of the present specification is a microfluidic device containing a four-sided microfluidic fluid chamber, for example having a volume of around 10-1000 nL. The microfluidic fluid chamber is surrounded by a heating element such as a resistor on a substrate having, for example, a thickness of 25-50 μm. The heating element is further surrounded by a thermally insulating layer having, for example, a thickness of 25 μm. In some examples, the insulator may have a thermal conductivity of less than 1 W/m k. The thermal cycling device also includes a heat sink made of, for example, aluminum or silicon that surrounds the insulative adhesive layer. In some examples, the heat sink may have a conductivity of greater than 1 W/m k. Such a device could be used to carry out PCR operations.

In some examples, the thermal cycling device has multiple fluid chambers stacked on top of each other with regions of the conductive body in between. Accordingly, in some examples instead of having a single fluid chamber for fluid, a thermal cycling device stacks multiple wide thin fluid chambers on top of each other, with highly conductive regions in between to wick away heat. Doing so facilitates using the same thermal engineering which allowed a single fluid chamber to heat and cool so fast, on multiple samples at once. In some examples, the fluid chambers could all be run with the same thermal protocol. In another example, each fluid chamber could have individual protocols. As the fluid chambers may be a few hundred microns thick, dozens of fluid chambers could be stacked and fit within a pocket-sized device.

Specifically, the present specification describes a thermal cycling device. The thermal cycling device includes 1) a fluid chamber to retain a fluid, 2) a heating element surrounding multiple sides of a cross-sectional perimeter of the fluid chamber, 3) an insulator surrounding multiple sides of a cross-sectional perimeter of the heating element, and 4) a conductive body surrounding multiple sides of a cross-sectional perimeter of the insulator.

In some examples, the heating element is disposed around a subset of the multiple sides of the cross-sectional perimeter of the fluid chamber. Still further in some examples, the insulator is disposed around a subset of the multiple sides of the cross-sectional perimeter of the heating element.

In some examples, the fluid chamber includes featured walls to increase heat transfer between the heating element and the fluid to be analyzed. The thermal cycling device may include a second heating element disposed within the fluid chamber.

In some examples, the thermal cycling device includes at least one of a variable thickness heating element and a variable thickness fluid chamber.

In some examples, the fluid chamber has a serpentine cross-sectional shape. In some examples, the thermal cycling device further includes a viewing window extending through the heating element, insulator, and conductive body. The thermal cycling device may also include multiple fluid chambers surrounded by a single heating element.

The present specification also describes a thermal cycling system. The thermal cycling system includes at least one thermal cycling device. Each thermal cycling device includes 1) a fluid chamber to retain a fluid, 2) a heating element disposed around all sides of a cross-sectional perimeter of the fluid chamber, the heating element to cyclically heat and cool the fluid to different temperatures, 3) an insulative adhesive disposed around all sides of a cross-sectional perimeter of the heating element, and 4) a conductive body surrounding all sides of a cross-sectional perimeter of the insulative adhesive.

In some examples, the thermal cycling system includes multiple thermal cycling devices which share a single conductive body. Fluid chambers of different thermal cycling devices may have different cross-sectional dimensions.

In some examples, the thermal cycling system includes multiple thermal cycling devices which share a single conductive body and the fluid chambers are rectangular and stacked such that short sides are adjacent one another.

In some examples, the thermal cycling system includes multiple thermal cycling devices which share a single conductive body and the fluid chambers are rectangular and stacked such that long sides are adjacent one another.

The present specification also describes a method. According to the method, a fluid chamber having a particular cross-sectional height is formed. A heating element is formed around multiple sides of the fluid chamber. A cross-sectional thickness of the heating element being determined based on the cross-sectional height of the fluid chamber. An insulative adhesive is formed around multiple sides of the heating element. A cross-sectional thickness of the insulative adhesive being determined based on: 1) the cross-sectional height of the fluid chamber and 2) the cross-sectional thickness of the heating element. A conductive body is formed around multiple sides of the insulative adhesive. A cross-sectional thickness of the conductive body being determined based on: 1) the cross-sectional height of the fluid chamber, 2) the cross-sectional thickness of the heating element, and 3) the cross-sectional thickness of the insulative adhesive.

In some examples, the cross-sectional thickness of the insulative adhesive is further determined based on a power of the heating element and a length of time to hold fluid at a particular temperature.

In summary, using such a thermal cycling device 1) provides quicker thermal cycling of fluid, on the order of 100 times faster than existing instruments; 2) provides more uniform temperature distributions; 3) expels less waste heat; 4) increases throughput via parallel thermal cycling of different samples; and 5) simplifies manufacturing as there are no moving parts and may include just rectilinear shapes which may be etched into silicon. However, the devices disclosed herein may address other matters and deficiencies in a number of technical areas.

As used in the present specification and in the appended claims, the term “thermal cycling device” refers to a combination of a fluid chamber, heating element, insulator, and conductive body.

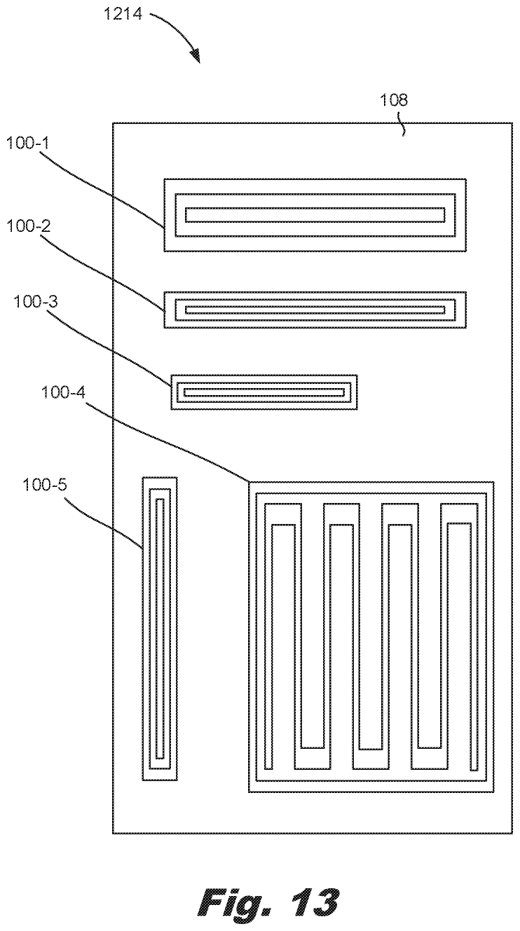

By comparison, as used in the present specification and in the appended claims, the term “thermal cycling system” refers to multiple thermal cycling devices. In some examples of a thermal cycling system, the components of the individual thermal cycling devices may be shared. For example, a thermal cycling system may include multiple thermal cycling devices, and each of the thermal cycling devices may share a common conductive body. FIGS. 13-15 depict such a shared-component thermal cycling system.

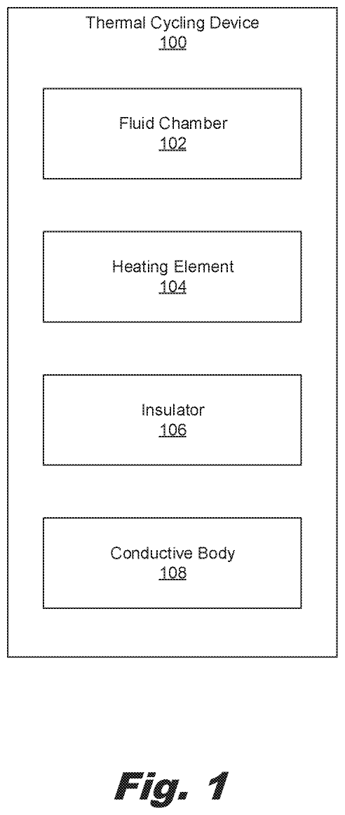

Turning now to the figures, FIG. 1 is a block diagram of a thermal cycling device (100) with a heating element (104) surrounding multiple sides of a fluid chamber (102), according to an example of the principles described herein. In some examples, the thermal cycling device (100) is a microfluidic structure. Such microfluidic structures may be a few square millimeters to a few square centimeters, and may provide efficient small-scale functionality. In other words, the components, i.e., fluid chamber (102), heating element (104), insulator (106), and/or conductive body (108) may be microfluidic structures. A microfluidic structure is a structure of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.).

The thermal cycling device (100) includes a fluid chamber (102) to retain a fluid. In some examples, the fluid chamber (102) holds fluid to be statically heated and cooled. That is, fluid is pumped into the fluid chamber (102) where it rests while the heating element (104) cyclically heats and cools it. Once the scientific operation is complete, the fluid is pumped out of the fluid chamber (102).

In another example, instead of pumping fluid into the fluid chamber (102), thermal cycling it, and then pumping it out at the end, the fluid may be continuously pumped through while the thermal cycling device (100) cycles. With a pump that runs continuously while the temperature cycles in the fluid chamber (102), there is a steady stream of processed fluid leaving the fluid chamber (102). This could save a few seconds of pumping time at the end. In this example, the fluid chamber (102) may be a fluid channel coupled at one end to a reservoir and directing fluid through the fluid channel towards an outlet.

The thermal cycling device (100) also includes a heating element (104) surrounding multiple sides of a cross-sectional perimeter of the fluid chamber (102). That is, the fluid chamber (102) has a cross-sectional area, a perimeter of which is either partially or completely surrounded by the heating element (104). In some examples, the heating element (104) includes a resistor formed on a substrate such as a layer of silicon material. As described above, doing so allows for the heating element (104) to have greater surface area contact with the fluid, thus increasing its ability to raise the temperature of the fluid inside. Doing so may increase the rate at which thermal cycling, and in particular PCR, may be performed.

Disposed around multiple sides of a cross-sectional perimeter of the heating element (104) is an insulator (106). The insulator (106) limits the amount of heat which enters the conductive body (108) while the heating element (104) heats the fluid. This keeps the conductive body (108) cool so that during the cooling stage, the energy from the heating element (104) and fluid may flow into the conductive body (108). Accordingly, the degree to which heat is drawn away from the fluid, and thus the length of the cycle time, may be impacted by the thickness of this insulator (106) and the thickness may be selectable to effectuate particular heat transfer rates.

Such an insulator (106) may be formed of materials such as an oxide, a glass, and different plastics. In some examples, the insulator (106) is made of a material that has a thermal conductivity of less than 1 W/m K. The insulator (106) may be an adhesive layer. That is, an adhesive may be used to affix the conductive body (108) to silicon on which a heating component such as a resistor resides. In some examples, this adhesive performs the second function of insulating, and thus gating the thermal heat transfer away from the heating element (104).

The thermal cycling device (100) also includes a conductive body (108) around multiple sides of a cross-sectional perimeter of the insulator (106). The conductive body (108) being highly conductive, draws heat away from the fluid, allowing rapid cooling of the fluid. Were such a conductive body (108) not present, the fluid would not cool as fast, thus increasing the time of each thermal cycle of a PCR operation. Accordingly, by including a conductive body (108), fluid cooling is increased, such that PCR cycle time and total PCR time is reduced. Such a conductive body (108) may be formed of a variety of materials including aluminum, silicon, or copper. The conductive body (108) may be formed of a material with a conductivity of greater than 1 W/m K.

In a specific example, the thermal cycling device (100) includes a wide thin fluid chamber (102), which may be between 10-200 μm thick and up to a few thousand μm wide. This fluid chamber (102) may be surrounded on 1, 2, 3, or 4 sides by a heating element (104) which heating element (104) may include a resistor. As energy is applied to the resistor it heats up, and transmits the heat energy to the fluid. The heating element (104) is surrounded by a thermal insulator (106). The thickness of this insulator (106) may be determined based on the thickness of the fluid chamber (102) and the power put into the resistor. In some examples, the insulator (106) is thick enough for the heat from the heating element (104) to just reach through the insulator (106) when the fluid hits its hot temperature.

These components, i.e., the fluid chamber (102), heating element (104), and insulator (106) are surrounded by a thermally conductive body (108), which may be silicon, copper, aluminum or another material. The conductive body (108) is large relative to the scale of the other components and sinks heat away from multiple sides of the heating element (104). The size of the conductive body (108) may be determined based on the size of the other components, i.e., the insulator (106), heating element (104), and fluid chamber (102).

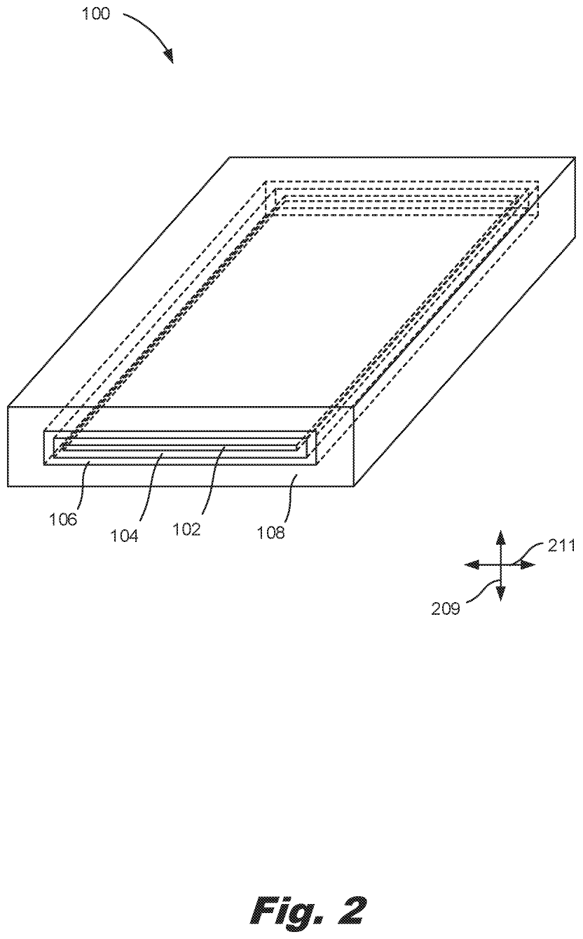

FIG. 2 is a diagram of a thermal cycling device (100) with a heating element (104) surrounding multiple sides of a fluid chamber (102), according to an example of the principles described herein. FIG. 2 clearly depicts the fluid chamber (102) being surrounded on multiple sides by a heating element (104), which heating element (104) is surrounded on multiple sides by an insulator (106), which insulator (106) is surrounded on multiple sides by a conductive body (108). As used in the present specification and in the appended claims a “height” of the fluid chamber (102) refers to dimension of the fluid chamber (102) in the vertical direction (209) as indicated on the compass of FIG. 2 and a “width” of the fluid chamber (102) refers to a dimension in the horizontal direction (211) as indicated on the compass. Still further, as used in the present specification and in the appended claims, the term “thickness” refers to a cross-sectional dimension of a component.

As can be seen in FIG. 2, the fluid chamber (102) is surrounded by the heating element (104) along its length. In this example, fluid may be introduced through a front of the fluid chamber (102). As heat is applied to the fluid chamber (102) from the heating element (104), the entire length of the fluid chamber (102) is heated.

As clearly depicted in FIG. 2, a conductive body (108) surrounds a thin, for example between 1 and 100 μm, layer of insulator (106) that surrounds a thin, for example between 1 and 100 μm, layer of a heating element (104), which includes a resistor, which encloses the fluid. In this example, the heating element (104) is part of an electric circuit allowing heat to be generated and flow into the fluid.

Note that in FIG. 2, the dimensions of the various components are not to scale but are enlarged to show detail. As described above, the dimensions of each component may be selected based on the others and may have a variety of values. For example, the fluid chamber (102) may be 1-100 μm high as measured in the vertical direction (209), and the heating element (104) may be 1-200 μm thick, while the insulator (106) may be thinner, for example between 0.5-200 μm. The conductive body (108) by comparison may be thicker, on the order of, for example, 2 millimeters (mm).

The conductive body (108) may be formed of a variety of materials. For example, the conductive body (108) may be formed of glass, plastic, or aluminum. In one test, the thermal conductivity of different conductive body (108) materials was evaluated where a power 1 watt (W) was applied to a heating element (104) which brought the heating element (104) to a temperature of 95 C after 0.009 seconds. After holding the heating element (104) at this temperature for 0.009 seconds, all of the fluid in the fluid chamber (102) reached a temperature of greater than 85 C. Following this protocol, the cooldown period was compared between a glass/plastic conductive body (108) and an aluminum conductive body (108). Analysis of the results indicates that the time it took for the maximum fluid temperature to drop to 55 C, where the whole system was at an ambient temperature of 25 C, was 0.099 seconds for the glass/plastic conductive body (108) as compared to 0.0865 seconds for the aluminum conductive body (108).

Another test was conducted to evaluate the effect of insulator (106) thickness on operation of a thermal cycling device (100). In this test, both the heating element (104) and the fluid volume were fixed for comparison sake. The conductive body (108) lid and substrate were large enough as compared to the other components of the system that they were effectively infinite on the timescale of one cycle. Accordingly, in such a model, varying the insulator (106) thickness may be used to determine thermal transfer properties of the thermal cycling device (100).

In this model, the thickness of the insulator (106) was adjusted to determine the changes in thermal power applied to the heating element (104). The results of this analysis follow in Table 1.

TABLE 1

| Effective Insulator | Power | Cycle | Cooldown |
|---|---|---|---|
| Thickness | Needed | Time | Only |
| 50 μ | 1.023 W | 0.0865 s | 0.0685 s |
| 25 μ | 1.06 W | 0.0540 s | 0.0360 s |
| 12.5 μ | 1.19 W | 0.0396 s | 0.0126 s |
| 6.25 μ | 1.58 W | 0.0329 s | 0.0149 s |

As depicted in Table 1, there is a linear relationship between cycle time and insulator (106) thickness and there is a sharply decreasing, potentially exponential, relationship between power and insulator (106) thickness.

In another test, the heating element (104) was heated up to an average temperature of 95 C and was held at that temperature long enough for the fluid to reach 85 C. Once this occurred, the energy was removed and a time was measured for the fluid to reach 55 C. This test was performed for fluid chambers (102) being 25 μm high and 10 μm high and 1000 μm in width. The heating element (104) was 25 μm thick around all sides of the fluid chamber (102), the conductive body (108) was aluminum, and had a thickness of 2,000 μm. In the different tests, the thickness of the insulator (106) was varied.

Results from the test run on a 25-μm fluid chamber (102) are presented in Table 2 and Table 3 includes results from the 10-μm fluid chamber (102) test.

TABLE 2
25-μm fluid chamber

| | | Power | Cycle |
|---|---|---|---|
| Insulator | | Needed (W) | Time (ms) |
| 25 | μ | 21.5 W | 26.5 |
| 12.5 | μ | 21.5 W | 12.45 |
| 6.25 | μ | 21.5 W | 6.58 |
| 1.5625 | μ | 25 W | 2.83 |

TABLE 3
10-μm fluid chamber

| | | Power | Cycle |
|---|---|---|---|
| Adhesive | | Needed (W) | Time (ms) |
| 25 | μ | 80.6 W | 18.9 |
| 12.5 | μ | 80.6 W | 8.9 |
| 6.25 | μ | 80.6 W | 4.4 |
| 1.5625 | μ | 92.1 W | 0.995 |

As seen from Table 2 and Table 3, there is a linear relationship between insulator (106) thickness and cool time, and a quadratic relationship between fluid and heat time. That is, four-sided heating and cooling as depicted in Tables 2 and 3 decouple heat up and cool down. Between Tables 2 and 3, less fluid resulted in higher power, lower total energy, and faster heat up and cooldown was affected by change in thermal mass.

In one specific example, a fluid chamber (102) cross section may be on the order of 0.22 mm². For a fluid chamber (102) height of 25 μm, the width of the fluid chamber (102) may be 8.8 mm.

In another specific example, to maintain the same area and given a fluid chamber (102) height of 50 μm, the width of the fluid chamber (102) may be 4.4 mm wide. In this example, the heating element (104) may have a thickness of 25 μm, an insulator (106) may have a thickness of 25 μm and there may be 2 mm of thickness of the conductive body (108) along the long edges (i.e., top and bottom in FIG. 2) and 25 μm of thickness of the conductive body (108) along the short edges (left and right in FIG. 2). A test was carried out with a thermal cycling device (100) having this geometry where the heating element (104) was heated to 95 C in 0.0025 s and held there for 0.0025 s. The fluid in the fluid chamber (102) reached a temperature greater than 85 C and cooled to a temperature of less than 55 C in less than 38.5 ms.

Running the same tests, but with a conductive body (108) specifically designated for use with fluidic structures, instead of an aluminum conductive body (108), the speed at which heat is leaked into the system is reduced as it has a lower thermal conductivity.

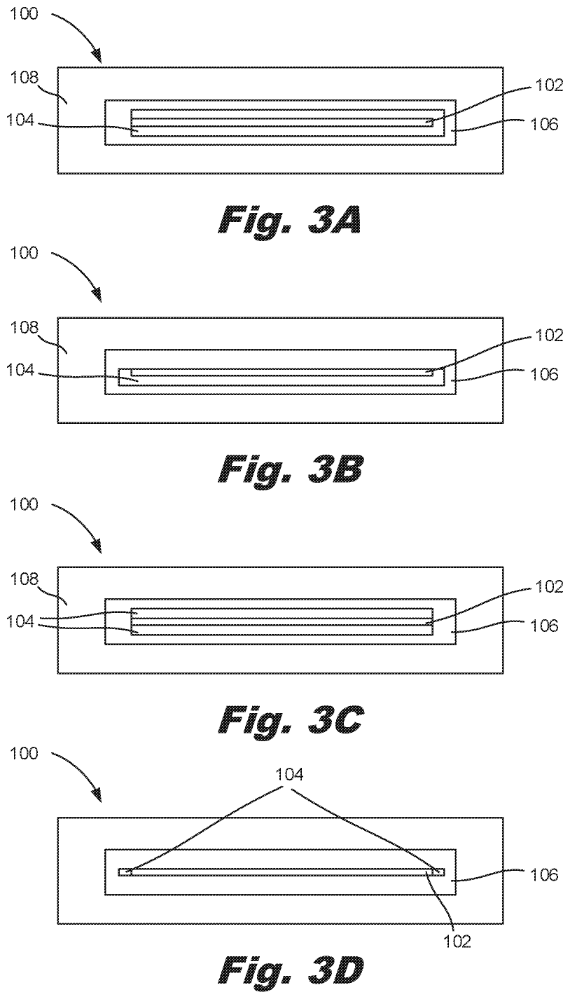

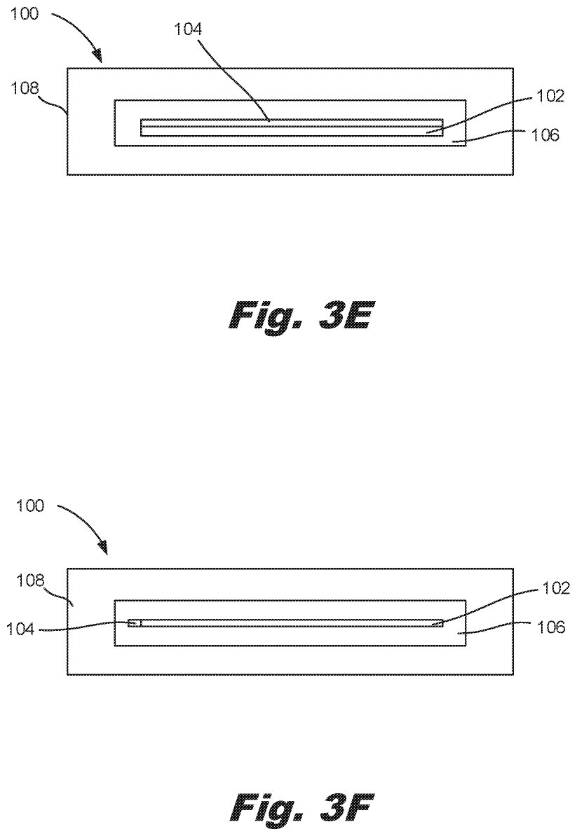

FIGS. 3A-3F are diagrams of thermal cycling devices (100) with heating elements (104) surrounding multiple sides of fluid chambers (102), according to an example of the principles described herein. That is, while FIG. 2 depicts the heating element (104) surrounding all sides of the cross-sectional perimeter of the fluid chamber (102), the heating element (104) may surround a subset of the multiple sides of the cross-sectional perimeter of the fluid chamber (102). That is, a heating element (104), which may include a resistor, may contact one, two, or three sides of the fluid chamber (102) instead of on four sides. The different versions may be less efficient in heating, but may be easier to build.

For example, FIG. 3A depicts an example where the heating element (104) is disposed on three sides, two long and one short, of the cross-sectional perimeter of the fluid chamber (102). FIG. 3B depicts an example where the heating element (104) is disposed on three sides, two short and one long, of the cross-sectional perimeter of the fluid chamber (102).

FIG. 3C depicts an example where the heating element (104) is disposed on two sides, the long sides, of the cross-sectional perimeter of the fluid chamber (102) and FIG. 3D depicts another example where the heating element (104) is disposed on two sides, this time the short sides, of the cross-sectional perimeter of the fluid chamber (102). In general, if there is a heating element (104) on one side of the fluid chamber (102), the heat travels across the whole body of the fluid in the fluid chamber (102). By comparison, when there are heating elements (104) on both sides, the heat just propagates halfway through, which results in heating the fluid four times faster.

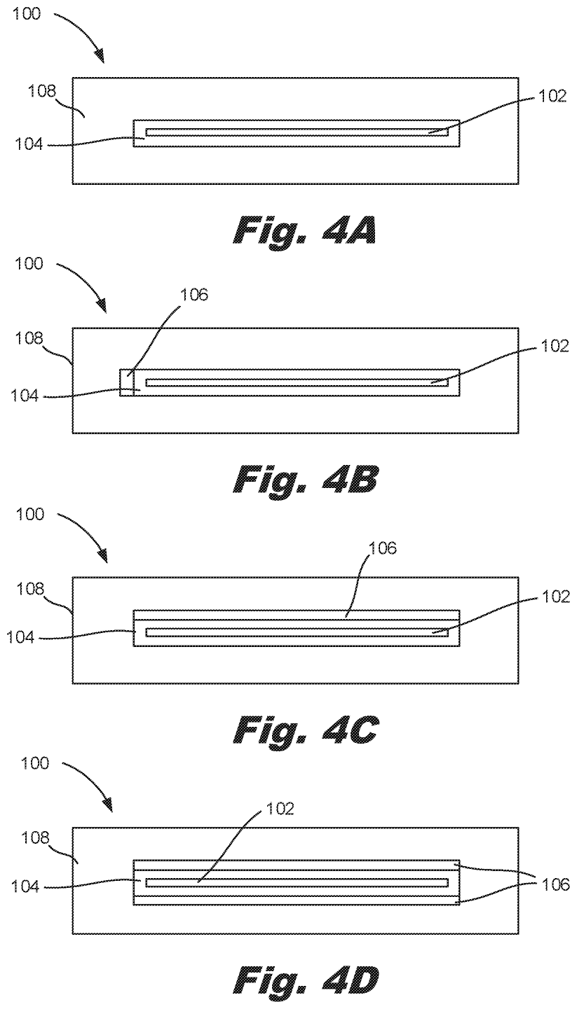

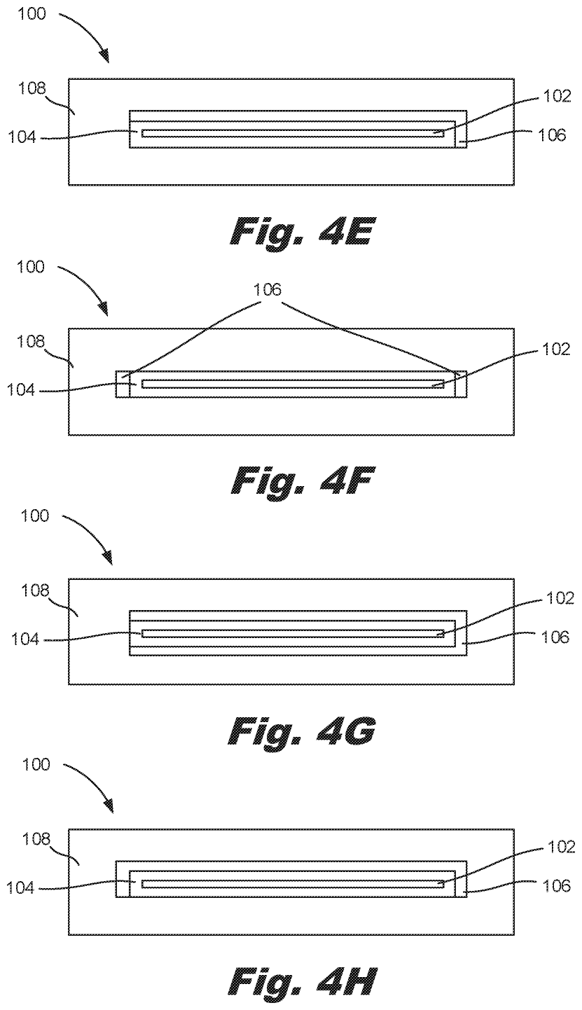

FIG. 3E depicts an example where the heating element (104) is disposed on just one side, a long side, of the cross-sectional perimeter of the fluid chamber (102) and FIG. 3F depicts another example where the heating element (104) is disposed on one side, this time a short side, of the cross-sectional perimeter of the fluid chamber (102). Note that in each example depicted in FIGS. 3A-3F, the insulator (106) and conductive body (108) surround all surfaces of the underlying component. However, the insulator (106) and/or the conductive body (108) may surround fewer than all of the sides as depicted in FIGS. 4A-4H.

FIGS. 4A-4H are diagrams of thermal cycling devices (100) with heating elements (104) surrounding multiple sides of fluid chambers (102), according to an example of the principles described herein. That is, while FIG. 2 depicts the insulator (106) surrounding all sides of the cross-sectional perimeter of the heating element (104), the insulator (106) may surround a subset of the multiple sides of the cross-sectional perimeter of the heating element (104). For example, the insulator (106) may surround one, two, or three sides of the heating element (104). Any of these arrangements may be easier to manufacture but may cause more waste heat to enter the system.

FIG. 4A depicts an example where there is no insulator (106). FIG. 4B depicts an example where the insulator (106) surrounds one side, a short side, of the cross-sectional perimeter of the heating element (104) and FIG. 4C depicts another example where the insulator (106) surrounds one side, this time a long side, of the cross-sectional perimeter of the heating element (104).

FIG. 4D depicts an example where the insulator (106) surrounds two sides, the long sides, of the cross-sectional perimeter of the heating element (104) and FIG. 4E depicts another example where the insulator (106) surrounds two sides, a long side and a short side, of the cross-sectional perimeter of the heating element (104). FIG. 4F depicts yet another example where the insulator (106) surrounds two sides, the short sides, of the cross-sectional perimeter of the heating element (104).

FIG. 4G depicts an example where the insulator (106) surrounds three sides, two long and one short, of the cross-sectional perimeter of the heating element (106). FIG. 4H depicts another example where the insulator (106) surrounds three sides, two short and one long, of the cross-sectional perimeter of the heating element (104). Note that in each example depicted in FIGS. 4A-4H, the heating element (104) surrounds all surfaces of the fluid chamber (102). However, the heating element (104) may surround fewer than all of the sides as depicted in FIGS. 3A-3F.

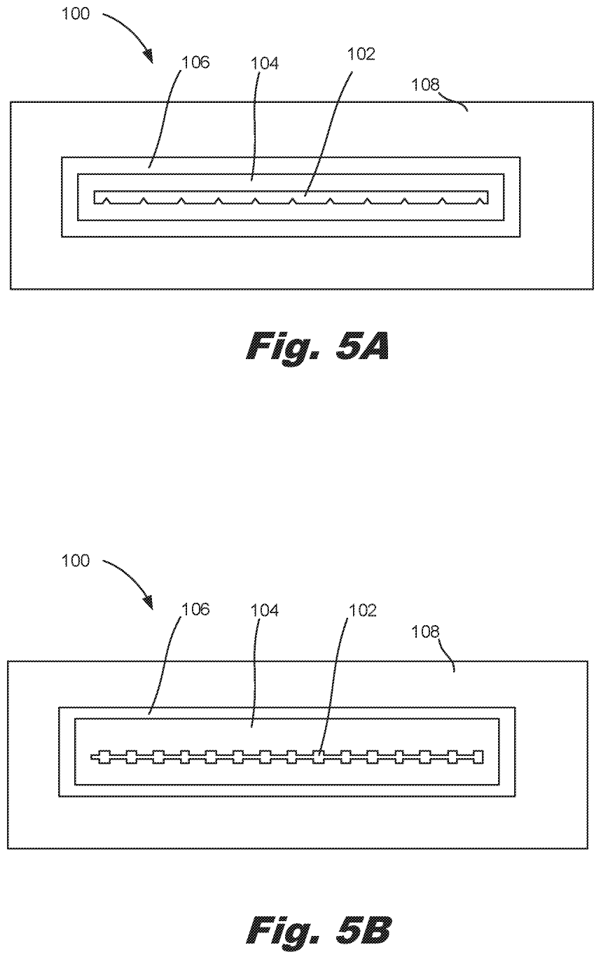

FIGS. 5A and 5B are diagrams of thermal cycling devices (100) with heating elements (104) surrounding multiple sides of fluid chambers (102), according to an example of the principles described herein. In some examples, the fluid chamber (102) has featured walls to increase heat transfer between the heating element (104) and the fluid to be analyzed. That is, instead of a smooth surface between the fluid and heating element (104), there may be a rough surface which increases the surface area interface and in turn decreases the effective diffusion length across the fluid. Doing so may increase the heat transfer between the fluid and the heating element (104) and could effectively reduce the fluid chamber (102) thickness.

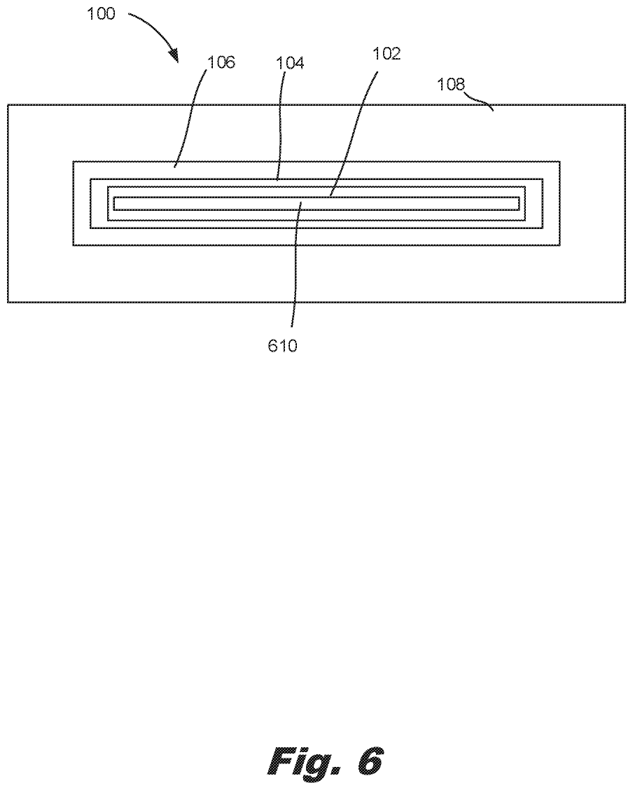

FIG. 6 is a diagram of a thermal cycling device (100) with a heating element (104) surrounding multiple sides of a fluid chamber (102), according to an example of the principles described herein. In the example depicted in FIG. 6, the thermal cycling device (100) includes a second heating element (610) disposed within the fluid chamber (102). That is, there may be a heating element (610) in the middle of the fluid in addition to the heating element (104) that surrounds the fluid chamber (102). Doing so may allow the fluid to heat up faster.

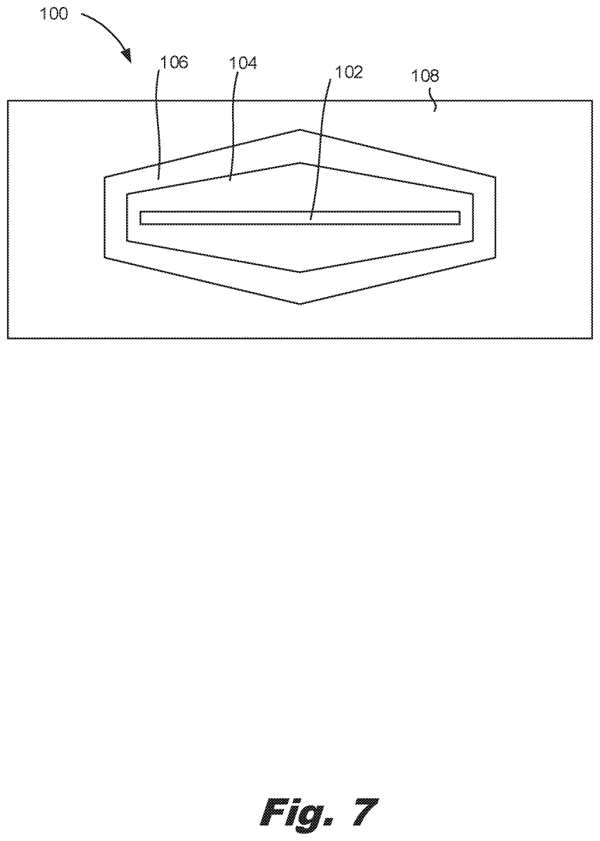

FIG. 7 is a diagram of a thermal cycling device (100) with a heating element (104) surrounding multiple sides of a fluid chamber (102), according to an example of the principles described herein. In the example depicted in FIG. 7, the heating element (104) and the insulator (106) are variable thickness components. In one example, such as that depicted in FIG. 7, they may be thicker towards a center of the fluid chamber (102). While FIG. 7 depicts a particular shape to the variable thickness heating element (104) and insulator (106) any number of profiles may be implemented.

Varying thickness may change the heating profile of the fluid. Specifically, in general the fluid in the center regions of the fluid chamber (102) may have a tendency to cool down faster. The variable thickness heating elements (104) and insulators (106) may increase power in the center of the fluid chamber (102) relative to ends and may even out fluid temperatures across a width of the fluid chamber (102). That is, it may be the case that fluid temperature at the ends, due to thermal transfer from three surfaces, may be greater than fluid temperatures near the center, due to thermal transfer from just two surfaces. Accordingly, the variable thickness heating element (104) produces more thermal energy transfer in the center to account for the natural dissimilarity in heating.

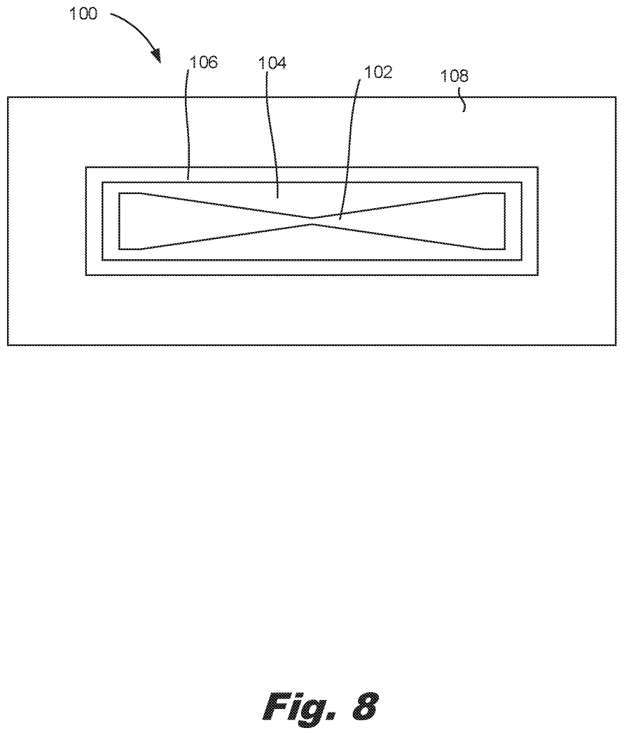

FIG. 8 is a diagram of a thermal cycling device (100) with a heating element (104) surrounding multiple sides of a fluid chamber (102), according to an example of the principles described herein. In the example depicted in FIG. 8, the fluid chamber (102) is a variable thickness fluid chamber (102). That is, as described above in connection with FIG. 7, due to the difference in thermal transfer at ends vs. the center of the fluid chamber (102), fluid at the ends may be hotter, and cool down slower as compared to fluid in the center of the fluid chamber (102). Accordingly, by having the fluid chamber (102) narrower in the center, inconsistencies within fluid chamber (102) heating characteristics may be equalized.

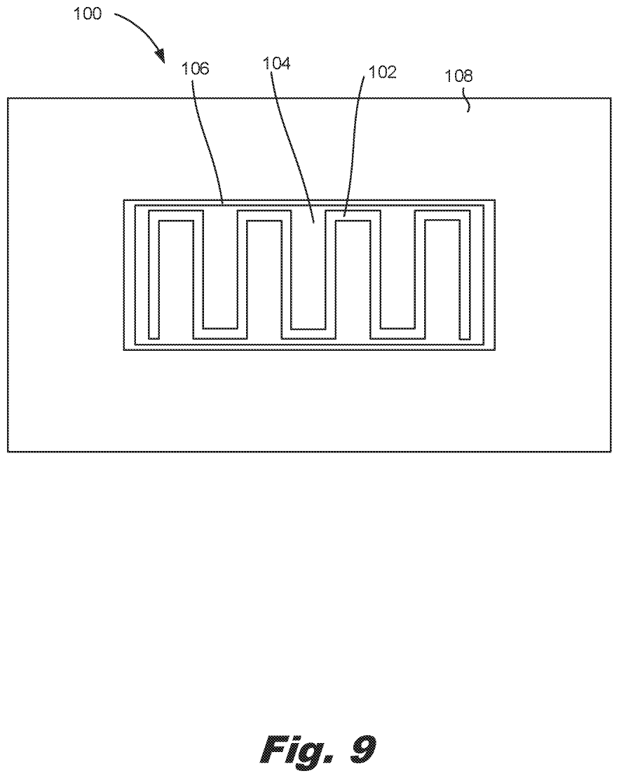

FIG. 9 is a diagram of a thermal cycling device (100) with a heating element (104) surrounding multiple sides of a fluid chamber (102), according to an example of the principles described herein. In the example depicted in FIG. 9, the fluid chamber (102) may have a serpentine cross-section. This increases the surface area contact between the heating element (104) and the fluid chamber (102) and also allows for more fluid volume to be contained in a smaller area.

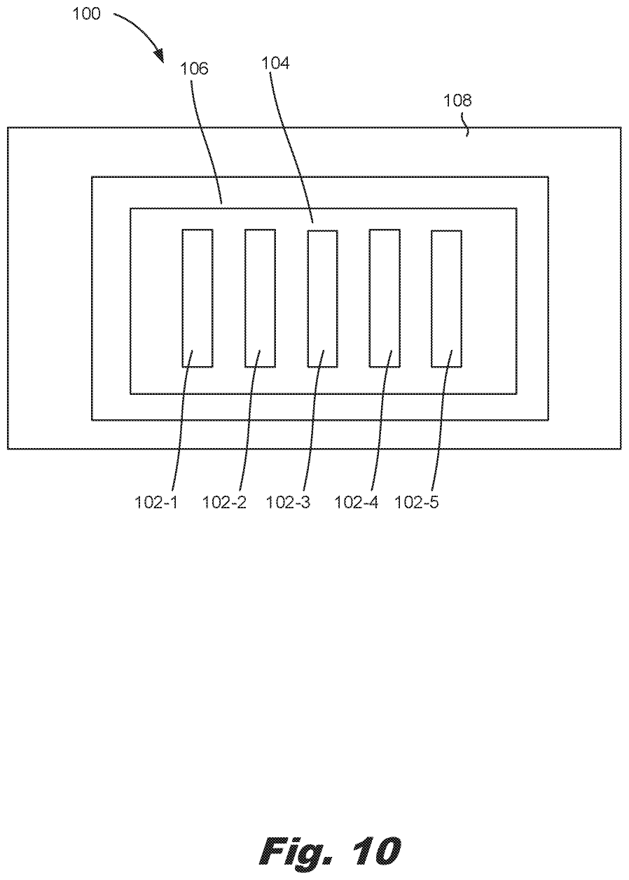

FIG. 10 is a diagram of a thermal cycling device (100) with a heating element (104) surrounding around multiple sides of a fluid chamber (102), according to an example of the principles described herein. In the example depicted in FIG. 10, the thermal cycling device (100) includes multiple fluid chambers (102-1, 102-2, 102-3, 102-4, 102-5) surrounded by a single heating element (104). Doing so may increase the efficiency of thermal cycling such that cycle times may be further reduced. For example, the heat-up time is constrained by the time it takes heat to diffuse through the liquid. This can be sped up by shortening the distance to the fluid chamber (102) and having multiple fluid chambers (102) disposed in a single heating element (104) does so.

In one particular example, each of the fluid chambers (102) may be 125 μm by 25 μm and the heating element (104), which may include a resistor, may be 25 μm thick between fluid chambers (102) and may be 50 μm thick around the edges.

A test was conducted on such a system which also had a 2 mm aluminum conductive body (108) surrounding the insulator (106). In this test, the heating element (104) was heated to 95 C in 0.5 ms and held there until 100% of the fluid was 85 C or more, which took between 0.7 and 1.2 milliseconds (ms). In this example, the cycle time is defined as the time for the maximum fluid temperature to cool down to 55 C. An adhesive insulator (106) thickness was varied and the results of the experiment are provided below in connection with Table 4.

TABLE 4

| | | | Hold time (not | |
|---|---|---|---|---|
| Insulator | | Cycle | include 0.5 ms | |
| Thickness | | time | heat) | Power |
| 50 | μ | 60.5 ms | 1.17 ms | 19.2 W |
| 12.5 | μ | 16.8 ms | 1.17 ms | 19.2 W |
| 3.125 | μ | 5.85 ms | 0.95 ms | 20.1 W |
| 1 | μ | 3.28 ms | 0.74 ms | 23.3 W |

As determined from Table 4, having multiple fluid chambers (102) per a single heating element (104) reduced the distance across the fluid by 5 times, which resulted in 25 times faster heating. The power draws are relatively constant between a single and multi-chamber setup because there is a fixed amount of energy used to raise the fluid and heating element (104) to temperature. Table 4 indicates that to decrease cooling time, thin layers of insulator (106) may be used.

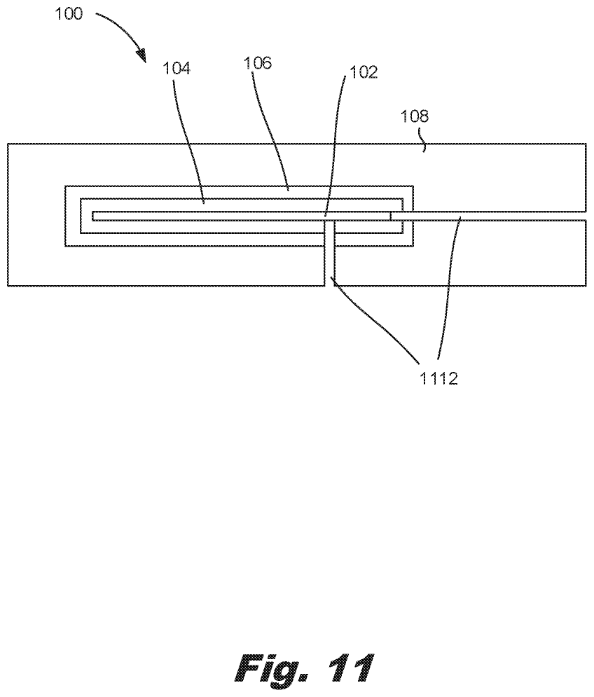

FIG. 11 is a diagram of a thermal cycling device (100) with a heating element (104) surrounding multiple sides of a fluid chamber (102), according to an example of the principles described herein. In the example depicted in FIG. 11, the thermal cycling device (102) has at least one viewing window (1112) extending through the heating element (104), insulator (106), and conductive body (108). Doing so allows a user to view the operations carried out within the fluid chamber (102) thus providing real time monitoring of the reaction. For example, such a viewing window (1112) facilitates tracking of the progress of the reaction without affecting the thermal physics. If positioned correctly, the viewing window (1112) could allow analysis of the depth of fluid. The viewing window (1112) may be formed of glass or another transparent material.

Note that while FIGS. 3A-FIG. 11 depict various examples of the thermal cycling device (100), any of the aforementioned examples could be combined. For example, a variable-sized heating element (104) as depicted in FIG. 7 may be used with fluid chambers (102) that have a surface roughness.

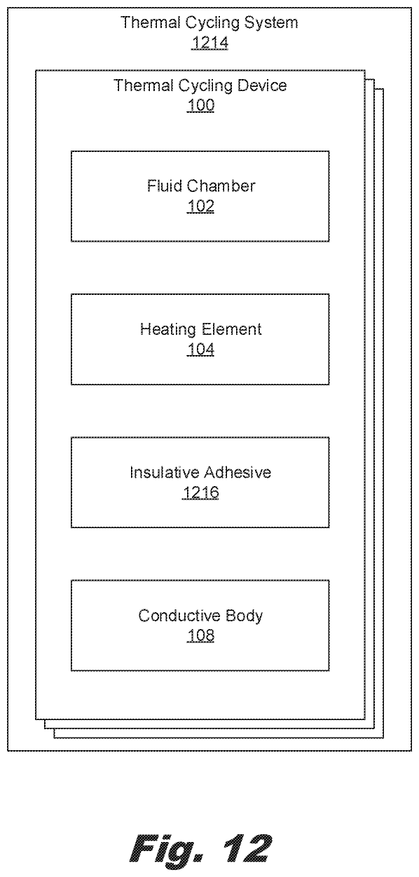

FIG. 12 is a block diagram of a thermal cycling system (1214) with a heating element (104) surrounding multiple sides of a fluid chamber (102), according to an example of the principles described herein. As described above, the thermal cycling system (1214) may include one or multiple thermal cycling devices (100). By including multiple thermal cycling devices (100), throughput is increased as multiple samples may be processed in parallel. Moreover, different thermal cycling parameters may be carried out in different thermal cycling devices (100) to increase not only the quantity, but the variety of analyses that may be carried out simultaneously.

As described above, each thermal cycling device (100) includes a fluid chamber (102) to retain a fluid and a heating element (104) disposed around all sides of a cross-sectional perimeter of the fluid chamber (102). As described above, the heating element (104) may cyclically heat and cool the fluid in the fluid chamber (102) to different temperatures. Each thermal cycling device (100) also includes an insulator (FIG. 1, 106) which in the example depicted in FIG. 12, is an insulative adhesive (1216). Such an insulative adhesive (1216) couples the conductive body (108) to the heating element (104) so as to allow the conductive body (108) to draw heat away from the heating element (104) during a cooling sub-cycle. The insulative adhesive (1216) also gates the heat transfer properties of the system.

FIG. 13 is a diagram of a thermal cycling system (1214) with heating elements (FIG. 1, 104) disposed around multiple sides of fluid chambers (FIG. 1, 102), according to an example of the principles described herein. As described above, the fluid analysis system (1214) may include multiple thermal cycling devices (100-1, 100-2, 100-3, 100-4, 100-5). For simplicity in FIG. 13 and others, components of each thermal cycling device (100) may be omitted for clarity. However, the thermal cycling devices (100) as depicted in FIGS. 12-15 may be similar to those described in connection with FIGS. 1-11. That is, while FIGS. 12-15 depict thermal cycling devices (100) with certain characteristics, similar thermal cycling devices (100) as described in connection with FIGS. 1-11 may be implemented in any of FIGS. 12-15.

In some examples, such as that depicted in FIG. 13, multiple thermal cycling devices (100) may share a single conductive body (108). As described above, doing so may further increase the rate of thermal cycling by reducing the time to heat up the fluid. Moreover, as depicted in the example of FIG. 13, fluid chambers (FIG. 1, 102) of different thermal cycling devices (102) may have different cross-sectional dimensions. For example, some may be larger, some may be smaller, and some may have other characteristics as described above such as serpentine fluid chambers (FIG. 1, 102), variable-sized fluid chambers (FIG. 1, 102), variable-sized heating elements (FIG. 1, 104) and/or featured fluid chambers (FIG. 1, 102). In so doing, the thermal cycling system (1214) provides a wide variety of heating environments such that different heating environments can be selected based on the fluid and/or experiment to be carried out. Moreover, by including the differently sized and/or shaped fluid chambers (FIG. 1, 102) on a single thermal cycling system (1214), the different experiments can be carried out simultaneously.

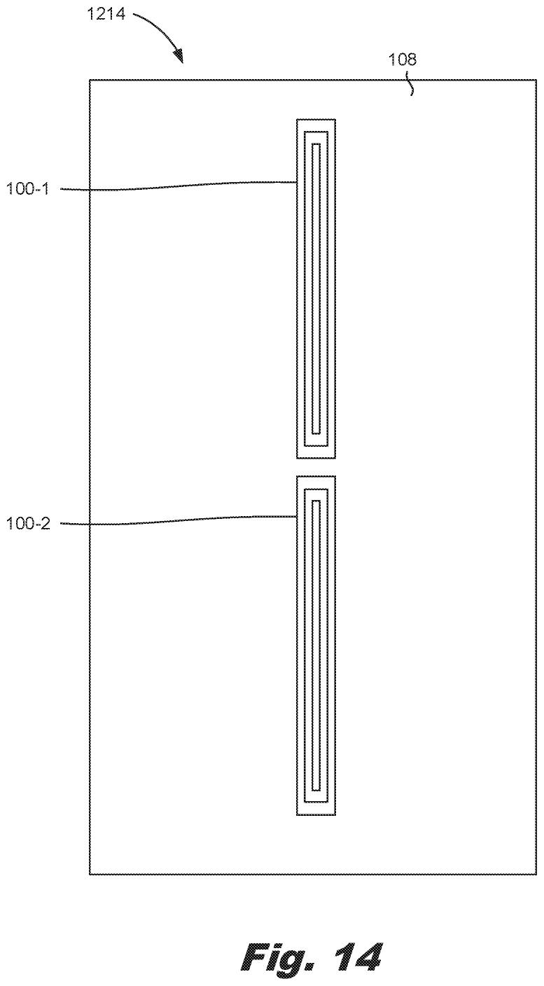

FIG. 14 is a diagram of a thermal cycling system (1214) with heating elements (FIG. 1, 104) disposed around multiple sides of fluid chambers (FIG. 1, 102), according to an example of the principles described herein. In the example depicted in FIG. 14, the thermal cycling system (1214) includes multiple thermal cycling devices (100-1, 100-2) that share a single conductive body (108). In this example, the thermal cycling devices (100) are rectangular and stacked such that short sides are adjacent one another. Doing so allows the different thermal cycling devices (100) to run on different thermal cycles. That is, the vertically-stacked thermal cycling devices (100-1, 100-2) may be thermally independent such that there is little thermal diffusion from one thermal cycling device (100-1) to another.

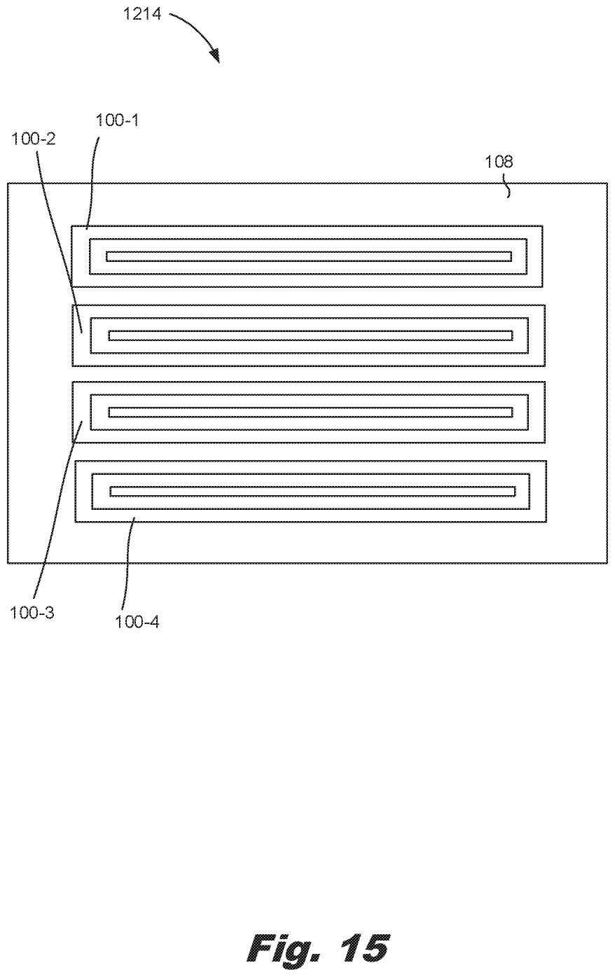

FIG. 15 is a diagram of a thermal cycling system (1214) with heating elements (FIG. 1, 104) surrounding multiple sides of fluid chambers (FIG. 1, 102), according to an example of the principles described herein. In the example depicted in FIG. 15, the thermal cycling system (1214) includes multiple thermal cycling devices (100-1, 100-2, 100-3, 100-4) that share a single conductive body (108). In this example, the thermal cycling devices (100) are rectangular and stacked such that long sides are adjacent one another. Doing so may be more space efficient.

A test was conducted on a thermal cycling system (1214) as depicted in FIG. 15. In this test, each thermal cycling device (100) had a 50 by 4,400 μm fluid chamber (FIG. 1, 102) and a 25-μm thick heating element (FIG. 1, 104) surrounding all sides of the fluid chamber (FIG. 1, 102). Insulator (FIG. 1, 106) and conductive body (FIG. 1, 108) thicknesses were adjusted.

Specifically, with regards to varying the insulator (FIG. 1 106), an aluminum conductive body (FIG. 1, 108) was implemented which had a top and bottom thickness of 25 μm and a side to side thickness of 5,000 μm extending past the edge of the horizontally-disposed thermal cycling devices (100). The insulative adhesive (FIG. 12, 1216) was tested at thicknesses of 12.5, 25, and 50 μm. A cycle is defined as the time to heat to 95 C from 25 C, and cool down to a max fluid temperature of 55 C. The heating element (FIG. 1, 104), which included a resistor, was heated to 95 C in 0.5 ms and held there for 1.15 ms. While varying the insulative adhesive (FIG. 12, 1216) thickness, the cycle time and temperature increase to the aluminum conductive body (FIG. 1, 108) were measured and results presented in Table 5 below:

TABLE 5

| | 12.5 μm | | 25 μm | | 50 μm | |
|---|---|---|---|---|---|---|
| Cycle time | 0.0492 | s | 0.0542 | s | 0.0624 | s |
| Aluminum Temp | 7.15 | C. | 6 | C. | 4.1 | C. |
| Increase | | | | | | |

From Table 5, it can be determined that there is a linear relationship between insulative adhesive (FIG. 12, 1216) thickness and cycle time. This is due to the fact that relative to the insulative adhesive (FIG. 12, 1216), the heating element (FIG. 1, 104) and conductive body (FIG. 1, 108) effectively have low thermal resistance. Accordingly, the thermal resistance of the system is close to the resistance of the insulative adhesive (FIG. 12, 1216), which is linear with length. The cycle time however is dominated by the long cool down time.

For the aluminum temperature, there is a constant amount of energy to raise the fluid and heating element (FIG. 1, 104) to temperature. The amount of heat that leaks during the heat up varies with the insulative adhesive (FIG. 12, 1216) thickness. If the thermal diffusion length during the heat up time (for this set of experiments about 60 μm) is less than the adhesive thickness, then it is constant. If not, the amount of heat that leaks through is proportional to 1/thickness because thermal resistance goes with thickness. In some examples, the insulative adhesive (FIG. 12, 1216) is 0.1-1 times the thermal diffusion length.

Note that when the conductive body (FIG. 1, 108) saturates with heat, conduction stops and cooling slows. Accordingly, the size of the conductive body (FIG. 1, 108) may be such that 20-30 cycles of the heating element (FIG. 1, 104) does not raise the conductive body (FIG. 1, 108) temperature from the ambient temperature to the anneal temperature for PCR. As such, it is desirable that the conductive body (FIG. 1, 108) raises no more than 1 C each cycle. Accordingly, in some examples, the conductive body (FIG. 1, 108) has a thermal mass such that 20 times the above energy does not raise its temperature from 25 C to 55 C.

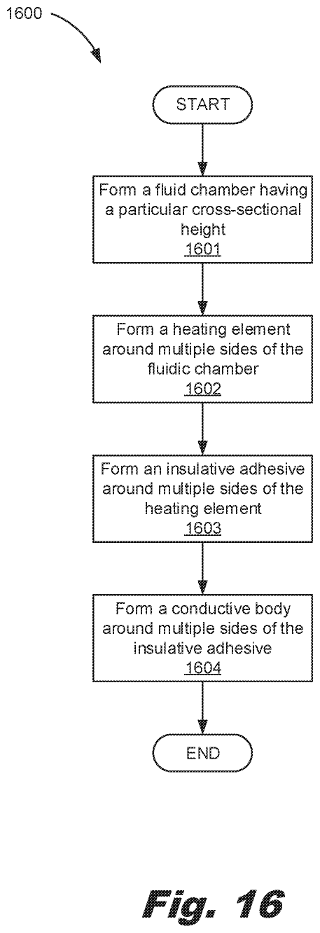

FIG. 16 is a flow chart of a method (1600) of forming a thermal cycling device (FIG. 1, 100) with a heating element (FIG. 1, 104) surrounding multiple sides of a fluid chamber (FIG. 1, 102), according to an example of the principles described herein.

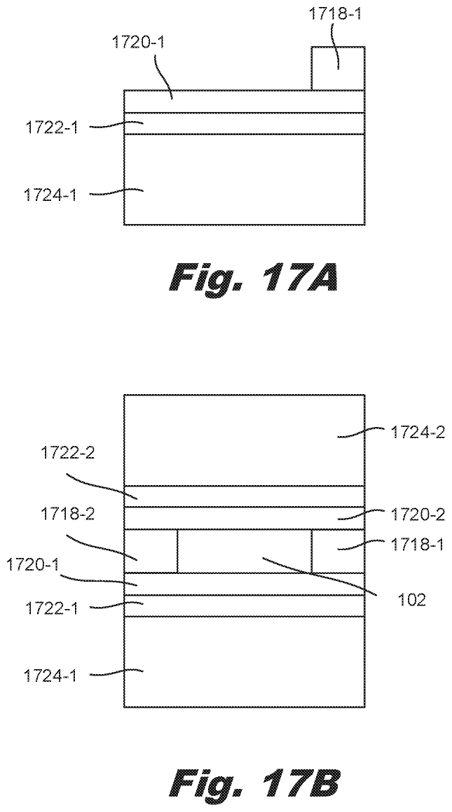

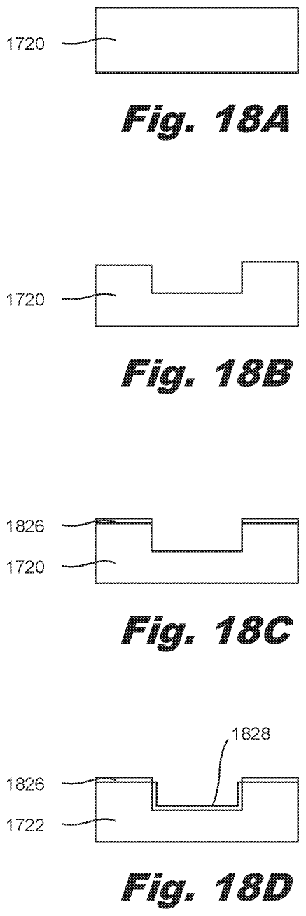

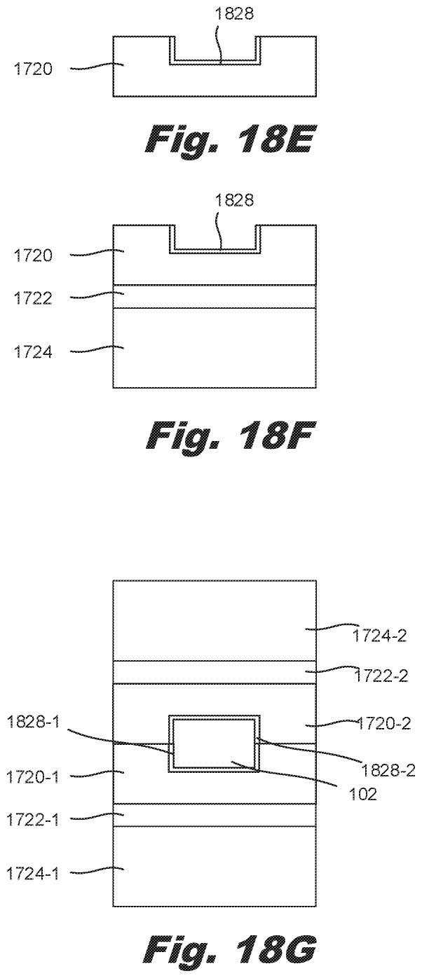

According to the method (1600), a fluid chamber (FIG. 1, 102) having a particular cross-sectional height is formed (block 1601). This may include etching a channel in a substrate. A heating element (FIG. 1, 104) is then formed (block 1062) around multiple sides of the fluid chamber (FIG. 1, 102). As depicted in FIGS. 17A-18G, this may include forming halves of the thermal cycling device (FIG. 1, 100) and then joining them to form an enclosed fluid chamber (FIG. 1, 102) surrounded by the heating element (FIG. 1, 104). As will be described below, a cross-sectional thickness of the heating element (FIG. 1, 104) may be based on the cross-sectional height of the fluid chamber (FIG. 1, 102). An insulative adhesive (FIG. 12, 1216) is then formed (block 1603) around multiple sides of the heating element (FIG. 1, 104), which heating element (FIG. 1, 104) may include a resistor and a substrate. A cross-sectional thickness of the insulative adhesive (FIG. 12, 1216) is determined based on 1) the cross-sectional height of the fluid chamber (FIGS. 1, 102) and 2) the cross-sectional thickness of the heating element (FIG. 1, 104). In some examples, the cross-sectional thickness of the insulative adhesive (FIG. 12, 1216) is further determined based on a power of the heating element (FIG. 1, 104) and a length of time to hold fluid at a particular temperature.

Lastly, a conductive body (FIG. 1, 108) is formed (block 1604) around multiple sides of the insulative adhesive (FIG. 12, 1216). A cross-sectional thickness of the insulative adhesive (FIG. 12, 1216) is determined based on: 1) the cross-sectional height of the fluid chamber (FIG. 1, 102); the cross-sectional thickness of the heating element (FIG. 1, 104); and the cross-sectional thickness of the insulative adhesive (FIG. 12, 1216).

A specific example of the formation of the thermal cycling device (FIG. 1, 100) is now presented. In general, there are three input variables, the dimensions of the fluid chamber (FIG. 1, 102), the power of the heating element (FIG. 1, 104) (and dimensions of the resistor), and how long it is desired to hold, T_{hold}, the fluid at some temperature, T_{high}, before allowing it to cool. Accordingly, a fluid chamber (FIG. 1, 102) height is chosen, which may be in the range of 5-100 μm, but may be in the range of 1-1000 μm. A fluid chamber (FIG. 1, 102) width is also selected, which may be in the range of 1 mm, but could be anywhere from 0.1 to 10 mm.

Next, a thickness of the heating element (FIG. 1, 104) is selected, which may be anywhere from 5 times to ⅕ the thickness of the fluid chamber (FIG. 1, 102).

As described above, in some examples, the conductive body (FIG. 1, 108) is large enough to absorb 30-40 times the energy used to heat the device once.

FIGS. 17A and 17B are diagrams of the formation of a thermal cycling device (FIG. 1, 100) with heating elements (FIG. 1, 104) around two sides of a fluid chamber (FIG. 1, 102), according to an example of the principles described herein. Such a manufacturing operation includes combining two thermal inkjet wafers and combining them. Specifically, as depicted in FIG. 17A, a first TIJ wafer includes a spacer layer (1718-1) which may be formed of SU8, a silicon layer (1720-1) which is disposed on an insulator layer (1722-1) and further disposed on a heat sink layer (1724-1) such as a silicon material or an aluminum material. In some examples, a resistor is formed on the silicon layer (1720-1). A second TIJ wafer is obtained, which includes its own spacer layer (FIG. 1718-2), silicon layer (1720-2), insulator layer (1722-2) and heat sink layer (1724-2). As depicted in FIG. 17B, the second TIJ wafer is inverted and aligned with the first TIJ wafer. Accordingly, a fluid chamber (102) is formed therein with the resistors and the silicon material layers (1720) forming the heating element (FIG. 1, 104), the insulator layers (1722-1, 1722-2) forming the insulator (FIG. 1, 106) and the heat sink layers (1724-1, 1724-2) forming the conductive body (FIG. 1, 108).

FIGS. 18A and 18G are diagrams of the formation of a thermal cycling device (FIG. 1, 100) with a heating element (FIG. 1 104) that surrounds four sides of a fluid chamber (102), according to an example of the principles described herein. As depicted in FIG. 18A, a silicon layer (1720) is obtained and as depicted in FIG. 18B, a channel is etched therein. In some examples, a resistor is formed on the silicon layer (1720). Following the etching of the silicon layer (1720), a photoresist (1826) is deposited on top surfaces of the silicon layer (1720) as depicted in FIG. 18C. The photoresist (1826) prevents the metal that is subsequently deposited from forming on these upper surfaces. As depicted in FIG. 18D, the metal layer (1828) is deposited. This metal layer (1828) forms part of the fluid chamber (102). After the metal layer (1828) is deposited, the photoresist is removed as depicted in FIG. 18E. As depicted in FIG. 18F, the silicon layer (1720) and metal layer (1828) assembly is deposited on an insulator layer (1722) and a heat sink layer (1724). This process is repeated for a second assembly, which second assembly is inverted and aligned with the first assembly. The joining of these two assemblies forms the fluid chamber (102). In this example, the metal layers (1828-1, 1828-2) define the fluid chamber (102), the silicon layer (1720) and the resistor disposed thereon define the heating element (FIG. 1, 104), and the insulator layers (1722-1, 1722-2) define the insulator (FIG. 1, 106) and the heat sink layers (1724-1, 1724-2) define the conductive body (FIG. 1, 108).

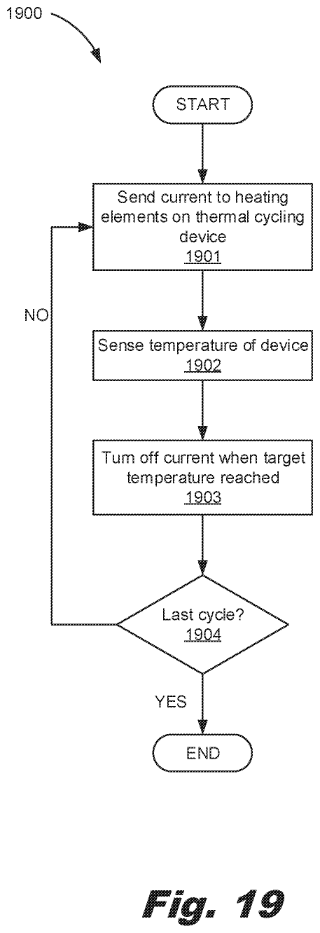

FIG. 19 is a flow chart of a method (1900) of using a thermal cycling device (FIG. 1, 100) with a heating element (FIG. 1, 104) surrounding multiple sides of a fluid chamber (FIG. 1, 102), according to an example of the principles described herein. Specifically, the method (1900) may be used in a PCR operation. During a PCR operation, a scientist may introduce a PCR master mix and a target DNA sample into the fluid chamber (FIG. 1, 102).

During PCR, the fluid in the fluid chamber (FIG. 1, 102) is cyclically heated and cooled, first to a temperature to separate the DNA into single strands. Accordingly, a current is sent (block 1901) to a heating element (FIG. 1, 104) that includes a thermal resistor disposed on a substrate. Responsive to this current, the resistor heats up and changes the temperature of the fluid, for example to around 100 C.

The temperature of the device is then sensed (block 1902) using a thermal sense resistor. When a target temperature is reached, that is when a temperature is reached that results in the DNA separating, the current is turned (block 1903) off to allow the fluid to cool, for example to around 50 C. During this cooling period, DNA primers attach to the separated strands of DNA. It is then determined (block 1904) if this was the last cycle, if not (block 1904, determination NO) the process repeats. For example, in PCR the fluid may be heated again to allow the replicated DNA strands to be extended by the polymerase in the PCR master mix. Accordingly, one PCR run has 3 phases, denaturing, annealing, and extending. This process of denaturing, annealing, and extending may be performed between 20-40 times to create a large sample from the target DNA sample.

If it was the last cycle (block 1904, determination YES), that is, if each of the cycles of multiple PCR runs have been performed, the process ends. As described above, using the thermal cycling device (FIG. 1, 100) with heating on multiple sides of the fluid chamber (FIG. 1, 102), each cycle may be done within milliseconds, such that each PCR run is done under a tenth of a second such that the complete PCR process could be performed within the time of a doctor's visit.

In summary, using such a thermal cycling device 1) provides quicker thermal-cycling of fluid, on the order of 100 times faster than other devices; 2) provides more uniform temperature distributions; 3) expels less waste heat; 4) increases throughput via parallel thermal cycling of different samples; and 5) simplifies manufacturing as there are no moving parts and may include just rectilinear shapes which may be etched into silicon. However, the devices disclosed herein may address other matters and deficiencies in a number of technical areas.

What is claimed is:

1. A thermal cycling device, comprising:
a fluid chamber to retain a fluid;
a heating element surrounding multiple sides of a cross-sectional perimeter of the fluid chamber;
an insulator surrounding multiple sides of a cross-sectional perimeter of the heating element; and
a conductive body surrounding multiple sides of a cross-sectional perimeter of the insulator.

2. The thermal cycling device of claim 1, wherein the heating element is disposed around a subset of the multiple sides of the cross-sectional perimeter of the fluid chamber.

3. The thermal cycling device of claim 1, wherein the insulator is disposed around a subset of the multiple sides of the cross-sectional perimeter of the heating element.

4. The thermal cycling device of claim 1, wherein the fluid chamber comprises featured walls to increase heat transfer between the heating element and the fluid to be analyzed.

5. The thermal cycling device of claim 1, further comprising a second heating element disposed within the fluid chamber.

6. The thermal cycling device of claim 1, further comprising at least one of:
a variable thickness heating element; and
a variable thickness fluid chamber.

7. The thermal cycling device of claim 1, wherein the fluid chamber has a serpentine cross-sectional shape.

8. The thermal cycling device of claim 1, further comprising a viewing window extending through the heating element, insulator, and conductive body.

9. The thermal cycling device of claim 1, further comprising multiple fluid chambers surrounded by a single heating element.

10. A thermal cycling system, comprising:
at least one thermal cycling device, each thermal cycling device comprising:
a fluid chamber to retain a fluid;
a heating element disposed around all sides of a cross-sectional perimeter of the fluid chamber, the heating element to cyclically heat and cool the fluid to different temperatures;
an insulative adhesive disposed around all sides of a cross-sectional perimeter of the heating element; and
a conductive body surrounding all sides of a cross-sectional perimeter of the insulative adhesive.

11. The thermal cycling system of claim 10:
comprising multiple thermal cycling devices which share a single conductive body; and
wherein fluid chambers of different thermal cycling devices have different cross-sectional dimensions.

12. The thermal cycling system of claim 10:
comprising multiple thermal cycling devices which share a single conductive body; and
wherein the fluid chambers are rectangular and stacked such that short sides are adjacent one another.

13. The thermal cycling system of claim 10:
comprising multiple thermal cycling devices which share a single conductive body; and
wherein the fluid chambers are rectangular and stacked such that long sides are adjacent one another.

14. A method, comprising:
forming a fluid chamber having a particular cross-sectional height;
forming a heating element around multiple sides of the fluid chamber, a cross-sectional thickness of the heating element being determined based on the cross-sectional height of the fluid chamber;
forming an insulative adhesive around multiple sides of the heating element, a cross-sectional thickness of the insulative adhesive being determined based on:
the cross-sectional height of the fluid chamber; and
the cross-sectional thickness of the heating element; and
forming a conductive body around multiple sides of the insulative adhesive, a cross-sectional thickness of the conductive body being determined based on:
the cross-sectional height of the fluid chamber;
the cross-sectional thickness of the heating element; and
the cross-sectional thickness of the insulative adhesive.

15. The method of claim 14, wherein the cross-sectional thickness of the insulative adhesive is further determined based on a power of the heating element and a length of time to hold fluid at a particular temperature.
